(19) United States
(12) Patent Application Publication
(10) Pub. No.: US 2025/0014087 A1
(43) Pub. Date: Jan. 9, 2025

(54) SYSTEMS AND METHODS FOR VARIANT ITEM IDENTIFICATION AND INTERFACE GENERATION

(71) Applicant: Walmart Apollo, LLC, Bentonville, AR (US)

(72) Inventors: Praveen Reddy Suram, Varthur (IN); Vaijenath Shankarrao Biradar, Marathahalli (IN); Apoorva Balyan, Devarabisanahalli (IN); Naman Parikh, Akshayanagar (IN); Suravi Shome, Patna (IN); Raunak Agrawal, Varthur (IN); Rudrani Ghosh, Bellandur (IN); Parthiban Ganapathy Pillai, HSR Layout (IN); Rahul Ghosh, Karnataka (IN); Ashwinikumar Purushottam Patil, Deverabisanhalli (IN)

(21) Appl. No.: 18/346,946

(22) Filed: Jul. 5, 2023

(51) Int. Cl. G06Q 30/0601

(52) U.S. Cl. CPC G06Q 30/0627; G06Q 30/0603; G06Q 30/0643

(57) ABSTRACT

Systems and methods for generating an interface including variant item elements are disclosed. A request for an interface including a search query is received from a first device and a set of candidate items is generated by a first level search model based on the search query. The first level search model generates a baseline value for each item variant in an item catalog including a weighted combination of a relevance label value and an engagement label value. The set of candidate items is selected based on the baseline value. A set of search results is generated by a second level search model based on the set of candidate items. An interface including interface elements representative of one or more item variants in the set of search results is generated and transmitted to the first device.

### TECHNICAL FIELD

This application relates generally to interface generation, and more particularly, to interface generation for faster identification of variant items.

### BACKGROUND

Electronic catalogs of items associated with network environments can include thousands or millions of items. Items included in electronic catalogs can include variant items, e.g., similar items having variations in one or more parameters. As one example, in the context of an e-commerce environment, an electronic catalog of items can include variant items having different sizes, colors, or other features that provide variation but do not themselves define a separate item.

In order to manage searching and presentation of results from electronic catalogs, some current search systems retrieve and present only a single version of any product from the catalog using a fixed criteria. For example, an item catalog can include multiple variants of a first product, such as a shirt in various colors and/or sizes. Some current search systems return, for example, the lowest priced variant of the shirt, regardless of the search query or search intent that produced the item. Such systems require users to complete additional navigation or interface tasks in order to identify an item that matches the search or intent.

### SUMMARY

In various embodiments, a system is disclosed. The system includes a non-transitory memory and a processor communicatively coupled to the non-transitory memory. The processor is configured to read a set of instructions to receive a request for an interface including a search query from a first device and generate a set of candidate items based on the search query. The set of candidate items is generated by a first level search model that generates a baseline value for each item variant in an item catalog. The baseline value comprises a weighted combination of a relevance label value and an engagement label value and the set of candidate items is selected based on the baseline value. The processor is further configured to generate a set of search results based on the set of candidate items using a second level search model, generate an interface including interface elements representative of one or more item variants in the set of search results, and transmit the interface to the first device.

In various embodiments, a computer-implemented method is disclosed. The computer-implemented method includes steps of receiving a request for an interface including a search query from a first device and generating a set of candidate items based on the search query. The set of candidate items is generated by a first level search model configured to generate a baseline value for each item variant in an item catalog. The baseline value comprises a weighted combination of a relevance label value and an engagement label value and the set of candidate items is selected based on the baseline value. The computer-implemented method further includes steps of implementing a second level search model to generate a set of search results based on the set of candidate items, generating an interface including interface elements representative of one or more item variants in the set of search results, and transmitting the interface to the first device.

In various embodiments, a non-transitory computer-readable medium having instructions stored thereon is disclosed. The instructions, when executed by a processor, cause a device to perform operations including receiving a request for an interface including a search query from a first device, generating a relevance label value for each item variant in an item catalog based on the search query, a set of user features, and a set of variant item features, generating an engagement label value for each item variant in the item catalog based on the search query and a set of historic interaction data, generating a weighted combination of the relevance label value and the engagement label value for each item variant in the item catalog, ranking each item variant in the item catalog by a first ranking criteria including the weighted combination of the relevance label value and the engagement label value to generate a ranked variant list, selecting a set of candidate items based on the ranked variant list, generating a set of search results by re-ranking the set of candidate items according to a second ranking criteria, generating an interface including interface elements representative of one or more item variants in the set of search results, and transmitting the interface to the first device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments.

FIG. 2 illustrates a network environment configured to provide an improved network interface including at least one interface item representative of an item variation, in accordance with some embodiments.

FIG. 3 illustrates an artificial neural network, in accordance with some embodiments.

FIG. 4 illustrates a tree-based artificial neural network, in accordance with some embodiments.

FIG. 5 illustrates a deep neural network (DNN), in accordance with some embodiments.

FIG. 6 is a flowchart illustrating a method of generating an interface including one or more identified variant items, in accordance with some embodiments.

FIG. 7 is a process flow illustrating various steps of the method of generating an interface including one or more variant items, in accordance with some embodiments.

FIG. 8 illustrates an interface including content elements representative of variant items, in accordance with some embodiments.

FIG. 9 is a flowchart illustrating a method of generating a trained machine learning model, in accordance with some embodiments.

FIG. 10 is a process flow illustrating various steps of the method of generating a trained machine learning model, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for generating interfaces including variations of an anchor item. In various embodiments, a system for generating an interface includes a variant generation system configured to select variant items for inclusion in a network interface page. The variant generation system is configured to receive at least product group (e.g. at least one anchor item representative of a product group). The product group can be identified using any suitable mechanism, such as, for example, a search engine or process. Product groups include logical groupings of the anchor item and variations of the anchor item. For example, in various embodiments, product groups can include items having variable sizes, colors, flavors, formats, titles, descriptions, etc. The variant generation system is configured to identify at least one variant of the at least one anchor item that more closely matches a search query and/or a user intent. The variant generation system provides the selected variant an interface generation system that generates an interface including the selected variant. The selected variant provides an interface shortcut that enables a user to reach a page or perform an interface interaction including the variant item without having to navigate through additional pages related to the anchor item or other variants of the anchor item.

In some embodiments, systems, and methods for generating an interface including at least one item variant includes one or more trained variant-aware recommendation models. The trained variant-aware recommendation models can include one or more models configured to utilize at least one variant signal in a baseline ranking for search. In some embodiments, the baseline ranking includes a search process including at least one variant signal. Variant signals can include, but are not limited to, variant item popularity, variant interactions over impressions, variant size signals, etc.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, neural networks which are trained (e.g., configured or adapted) to generate a set of search results that includes variant items relevant to a search query or customer intent, are disclosed. A neural network trained to generate relevant variant items may be referred to as a trained variant-aware search model. A trained variant-aware search model can be configured to receive a set of input data, such as an anchor item, textual input, etc. and identify a set of items selected from a catalog most relevant to the search input, where the relevance determination includes one or more variant signals. In some embodiments, variant signals can be utilized to find optimal weights for baseline ranker features.

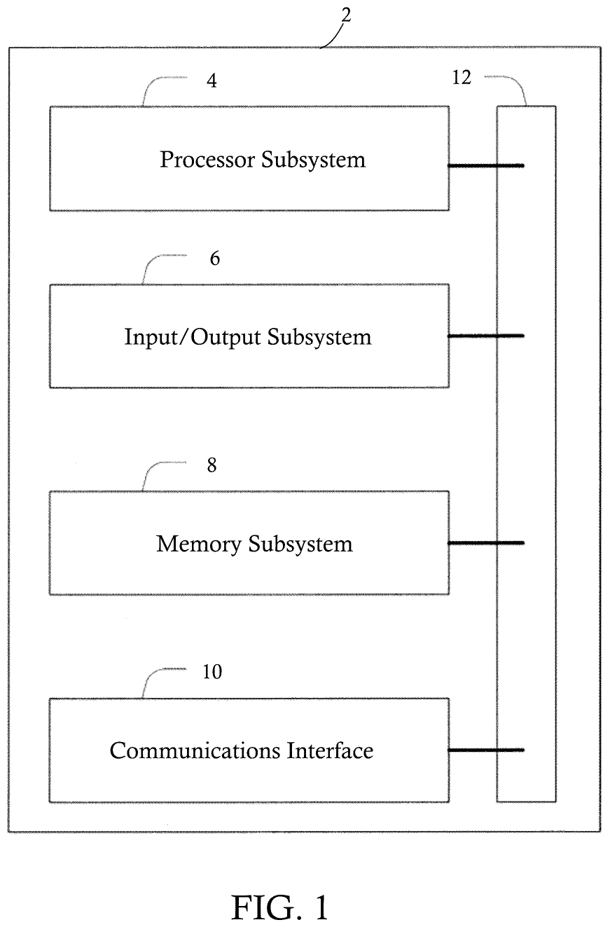

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electro-magnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electro-magnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for end-to-end simulation including hybrid input modeling, as described herein. The instruction set can be stored in any acceptable form of machine-readable instructions, including source code or various appropriate programming languages. Some examples of programming languages that can be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor subsystem 4.

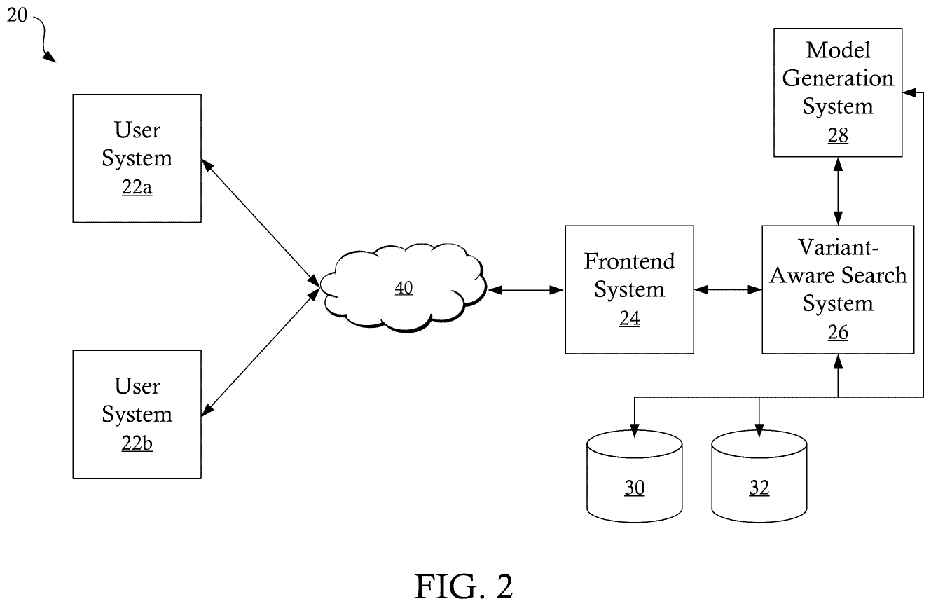

FIG. 2 illustrates a network environment 20 configured to provide an improved network interface including at least one interface item representative of an item variation, in accordance with some embodiments. The network environment 20 includes a plurality of systems configured to communicate over one or more network channels, illustrated as network cloud 40. For example, in various embodiments, the network environment 20 can include, but is not limited to, one or more user systems 22a, 22b, a frontend system 24, a variant-aware search system 26, a model generation system 28, a variant feature database 30, and a model store database 32. It will be appreciated that any of the illustrated systems can include a system as described above in conjunction with FIG. 1. Although specific embodiments are discussed, herein it will be appreciated that additional systems, servers, storage mechanism, etc. can be included within the network environment 20.

Further, although embodiments are illustrated herein having individual, discrete systems, it will be appreciated that, in some embodiments, one or more systems can be combined into a single logical and/or physical system. For example, in various embodiments, one or more of the frontend system 24, the variant-aware search system 26, the model generation system 28, the variant feature database 30, and the model store database 32 can be combined into a single logical and/or physical system. Similarly, although embodiments are illustrated having a single instance of each system, it will be appreciated that additional instances of a system can be implemented within the network environment 20. In some embodiments, two or more systems can be operated on shared hardware in which each system operates as a separate, discrete system utilizing the shared hardware, for example, according to one or more virtualization schemes.

In some embodiments, the user systems 22a, 22b are configured to receive and/or generate a user interface to allow a user to interact with services and/or resources provided by a network system, such as frontend system 24. The user interface can include any suitable interface, such as, for example, a mobile device application interface, a network interface, and/or any other suitable interface. For example, in some embodiments, the frontend system 24 includes an interface generation engine configured to generate a customized network interface and provide the customized network interface, and/or instructions for generating the customized network interface, to a user system 22a, 22b, which displays the user interface via one or more display elements. The customized network interface can include any suitable network interface, such as, for example, an e-commerce interface, a service interface, an intranet interface, and/or any other suitable user interface. In some embodiments, the customized interface includes a webpage, web portal, intranet page, application page, and/or other interactive interface. The customized network interface includes at least one interface item representative of a variation of an anchor item, where the variant item has a higher relevance with respect to a search query or user intent provided through the customized network interface.

In some embodiments, the frontend system 24 is in signal communication with a variant-aware search system 26 configured to generate search results including at least one variation of an anchor item having a higher relevant with respect to a search query or a user intent. The frontend system 24 and/or the variant-aware search system 26 can implement a variant-aware search model configured to generate search results via a search model configured to utilize one or more variant signals to generate search results relevant to a search query or user intent. For example, in some embodiments, a variant-aware search model is configured to receive a search query and generate search results utilizing variant signals such as variant item popularity, variant item interactions-over-impressions, variant size signals, variant item level engagement, variant item titles, variant item attributes, and/or other variant item signals. Although specific embodiments are discussed herein, it will be appreciated that any suitable variant signals can be used.

In some embodiments, the variant-aware search system 26 is configured to receive a search query, for example, via a search input provided in a network interface page. The search query can include one or more search terms related to one or more items within a catalog of items associated with the network interface. For example, in some embodiments, a search query can relate to items included within an e-commerce catalog. The variant-aware search system 26 is configured to generate a set of search results that include variations of anchor items that are not typically displayed in some existing search systems. The variant-aware search system 26 includes a variant-aware search model that is configured to utilize one or more variant signals when identifying search results for the search query. As discussed in greater detail below, in some embodiments, the variant-aware search model is configured to generate a set of search results for display to a user that each include an interface shortcut configured to allow a user to interact with an interface to perform one or more functions, such as navigating to a different interface page, selecting an item for additional interactions, etc.

In some embodiments, trained models can be generated by a model generation system 28. The model generation system 28 is configured to generate one or more trained models using, for example, iterative training processes. For example, in some embodiments, a model training engine is configured to generate a trained variant-aware search model. In some embodiments, the model training system is configured to receive set of items having variants, a set of search queries, a set of user intent features, and a set of variant features, and generate a trained variant-aware search model. Generated models can be stored in any suitable storage mechanism, such as, for example, the model store database 32.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

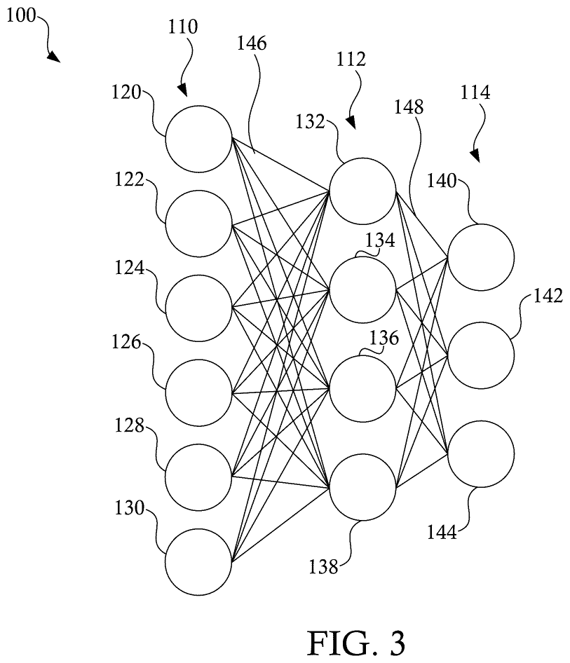

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1], within the interval [0, 1], and/or, within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein y is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

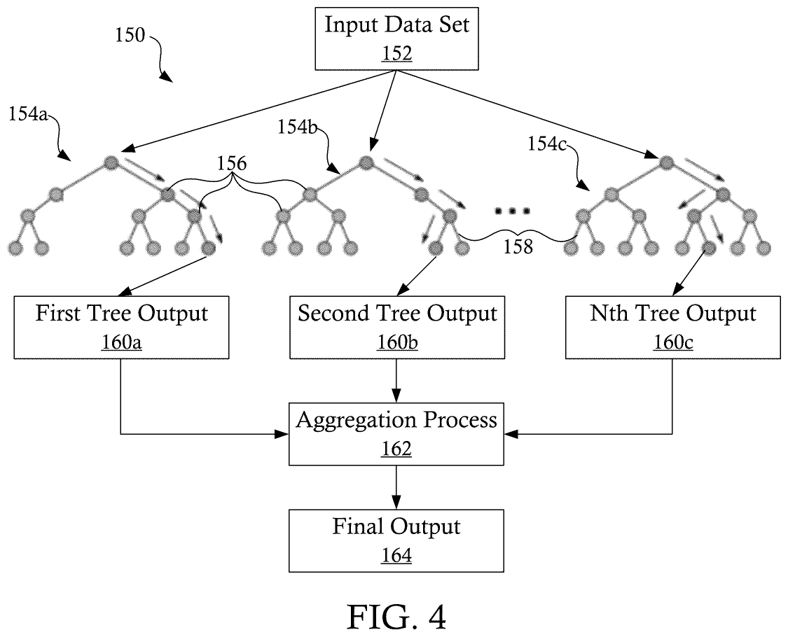

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

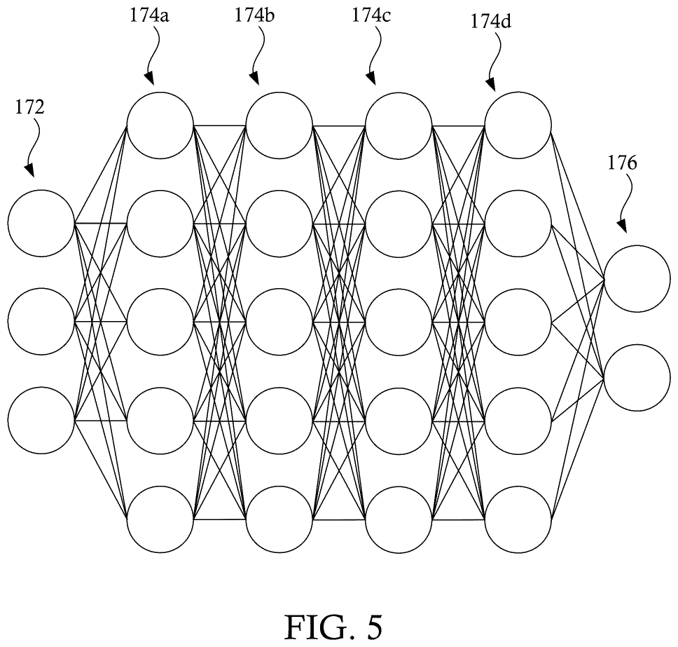

FIG. 5 illustrates a deep neural network (DNN) 170, in accordance with some embodiments. The DNN 170 is an artificial neural network, such as the neural network 100 illustrated in conjunction with FIG. 3, that includes representation learning. The DNN 170 can include an unbounded number of (e.g., two or more) intermediate layers 174a-174d each of a bounded size (e.g., having a predetermined number of nodes), providing for practical application and optimized implementation of a universal classifier. Each of the layers 174a-174d can be heterogenous. The DNN 170 can is configured to model complex, non-linear relationships. Intermediate layers, such as intermediate layer 174c, can provide compositions of features from lower layers, such as layers 174a, 174b, providing for modeling of complex data.

In some embodiments, the DNN 170 can be considered a stacked neural network including multiple layers each configured to execute one or more computations. The computation for a network with L hidden layers can be denoted as:

$$f ( i ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a pre-activation function and h^{(l)}(x) is a hidden-layer activation function providing the output of each hidden layer. The preactivation function a^{(l)}(x) can include a linear operation with matrix W^{(l)} and bias b^{(l)}, where:

a^{(l)}(x)=W^{(l)}x+b^{(l)}

In some embodiments, the DNN 170 is a feedforward network in which data flows from an input layer 172 to an output layer 176 without looping back through any layers. In some embodiments, the DNN 170 can include a backpropagation network in which the output of at least one hidden layer is provided, e.g., propagated, to a prior hidden layer. The DNN 170 can include any suitable neural network, such as a self-organizing neural network, a recurrent neural network, a convolutional neural network, a modular neural network, and/or any other suitable neural network.

In some embodiments, a DNN 170 can include a neural additive model (NAM). An NAM includes a linear combination of networks, each of which attends to (e.g., provides a calculation regarding) a single input feature. For example, an NAM can be represented as:

y=β+f₁(x₁)+f₂(x₂)+ . . . +fₖ(x_{K})

where β is an offset and each fᵢ is parametrized by a neural network. In some embodiments, the DNN 170 can include a neural multiplicative model (NMM), including a multiplicative form for the NAM mode using a log transformation of the dependent variable y and the independent variable x:

$$y = {e}^{β} {e}^{f ( logx )} {e}^{{\sum }_{i} {f}_{i}^{d} ( {d}_{i} )}$$

where d represents one or more features of the independent variable x.

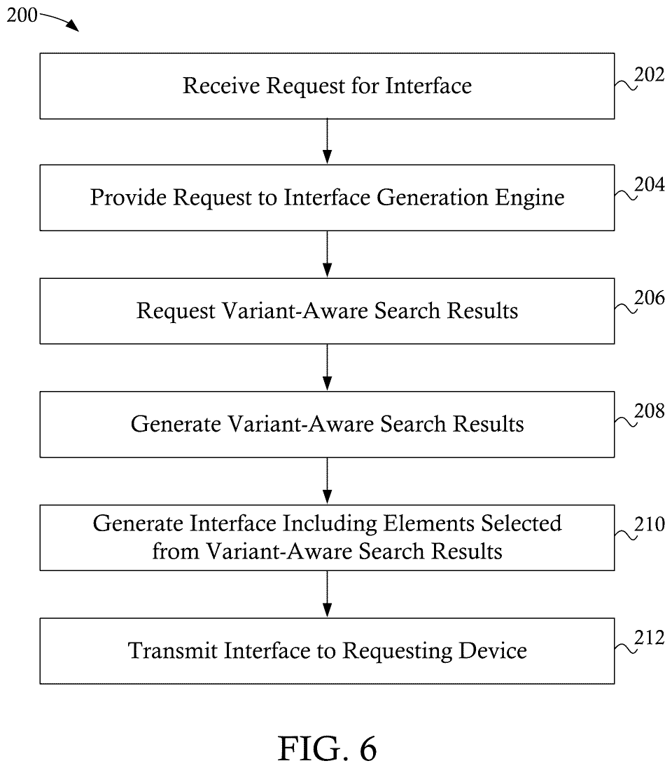

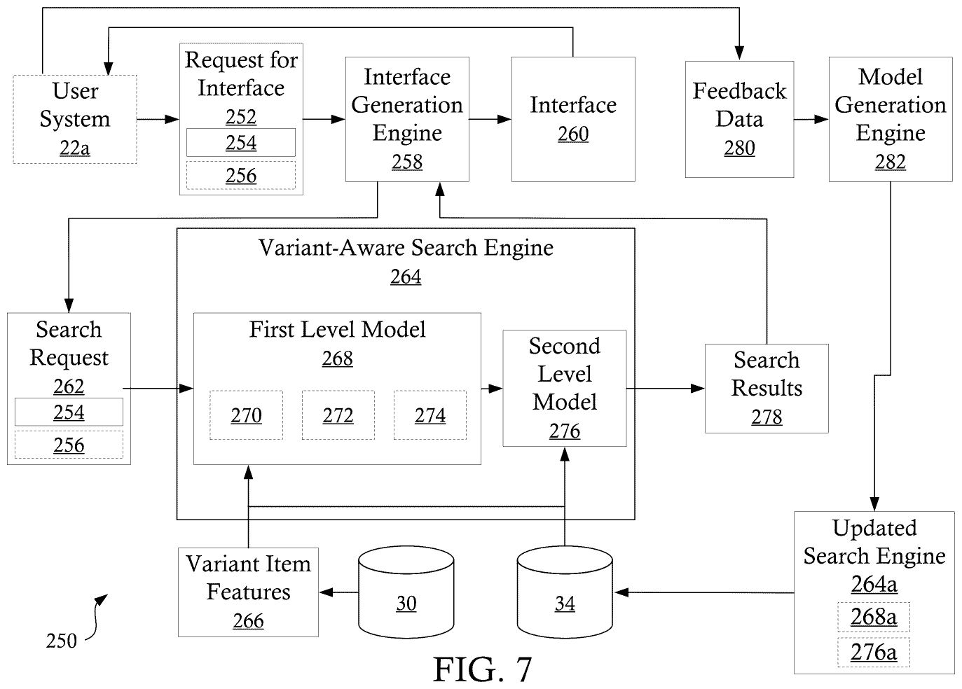

FIG. 6 is a flowchart illustrating a method of generating an interface 200 including one or more variant items, in accordance with some embodiments. FIG. 7 is a process flow 250 illustrating various steps of the method of generating an interface 200 including one or more variant items, in accordance with some embodiments. At step 202, a request for an interface 252 is received. The request for the interface 252 can be received by any suitable system, such as, for example, a frontend system 24. In some embodiments, the request for the interface 252 includes user data, such as, for example, a user identifier, context data, session data, and/or any other suitable user data. The user data can be generated by any suitable mechanism, such as, for example, a cookie, beacon, and/or other identifier stored on and/or provided to a user system 22a, 22b.

In some embodiments, the request for the interface 252 includes a search query 254. The search query 254 can be generated by a user system interacting with one or more interface pages associated with a network interface. For example, in some embodiments, the search query 254 can include an alphanumeric input, such as a search string, an item identifier, etc. provided to a search bar or other search component presented within an interface page, such as a search page, home page, etc. of a network interface. An alphanumeric search string can include one or more alphanumeric entries (e.g., words, phrases, numbers, etc.) indicating a scope or target of a search. Similarly, an item identifier can identify one or more anchor items to be used as a basis of a search for similar and/or related items. As another example, in some embodiments, a search query 254 can be provided through one or more interactions with interface elements of an interface, such as, for example, selecting an item element that is programmatically generated to request an interface page including search results related to the item element. In the context of an e-commerce network interface, a search query 254 can include, but is not limited to, one or more descriptors for items of interest as provided by a user device. In some embodiments, the search query 254 is received by one or more systems, such as, for example, a frontend system 24 and/or a variant-aware search system 26.

In some embodiments, the request for the interface 252 includes user signals 256 representative of one or more features of a user when the request for the interface 252 was generated. User features can include, but are not limited to, user intent features, user journey features, user system features, session data, etc. In some embodiments, user signals 256 can be generated using any suitable mechanism, such as, for example, a cookie, beacon, and/or other data element generated by and/or stored on a user system 22a, 22b. In some embodiments, user signals 256 can be generated by a server or other network interface device, such as a frontend system 24, based on interactions between a user device and a network interface. The user signals 256 can include, but are not limited to, one or more intent signals representative of a user intent, session journey, etc., one or more historical feature signals representative of prior interactions between users (e.g., the same user and/or different users) with the network interface and/or information provided by the user regarding user preferences, and/or any other suitable signals.

At step 204, the request for the interface 252 is provided to an interface generation engine 258. The interface generation engine 258 is configured to generate a user interface 260 including the requested content elements. For example, in some embodiments, when the request for the interface 252 includes a search query 254, the interface generation engine 258 is configured to generate a user interface 260 including search results responsive to the search query 254. As discussed in greater detail below, the search results included in the user interface 260 include variant-aware search results including one or more variant item elements having a higher relevance to the search query 254 and/or having a higher engagement prediction.

At step 206, the interface generation engine 258 generates and sends a search request 262 for a set of search results to a variant-aware search engine 264 and, at step 208, the variant-aware search engine 264 generates and returns a set of variant-aware search results 278. The variant-aware search engine 264 is configured to receive the search query 254, one or more variant level item signals 266, and/or one or more user signals 256. The variant level item signals 266 are representative of one or more features or parameters of an item. In some embodiments, the variant level item signals 266 include signals are different for two or more variants, such as, for example, variant item popularity, variant item interactions over impressions, variant item size, variant item color, variant item flavor, variant item format, variant item title, variant item description, etc. In some embodiments, the variant level item signals 266 include signals that are shared across two or more variants, such as, for example, a shared title, shared description, shared variant feature (e.g., two variants can share a size, color, etc.), brand, etc.

In some embodiments, the variant-aware search engine 264 includes a trained first level search model 268 (also referred to herein as a baseline search model), configured to select a set of M candidate items (where M is an integer greater than 1) selected from items within an item catalog associated with the network interface (also referred to herein as baseline items). The set of candidate items can include any suitable number of items (M), such as, for example, 128 items, 256 items, 300 items, 400 items, 512 items, 550 items, 600 items, etc. The trained first level search model 268 is configured to select a single variant for each product category (e.g., each item) included in the set of candidate items, e.g., an item having N variants (where N is an integer greater than 2) will be represented by a single item in the set of M candidate items.

In some embodiments, the selected variant for each item is the variant having a highest baseline value. The trained first level search model 268 can be configured to generate baseline value by combining a relevance label (RL) value (also referred to as a relevance score) and an engagement label (EL) value (also referred to as an engagement score) according to one or more predetermined weights. In some embodiments, the variant-aware search engine 264 is configured to generate an EL value and/or a RL value for each item variant in an item catalog (or a selected subset thereof) based on the received search query 254, user signals 256, and/or variant level item signals 266. The trained first level search model 268 selects the item variant having the highest baseline value for inclusion in the set of candidate items.

In some embodiments, the variant-aware search engine 264 is configured to combine an EL value and a RL value for each item variant to generate a baseline value (e.g., final label value) for the respective item variant. For example, in some embodiments, the final label value can be determined as:

FL=EL^{W}*RL^{(1-W)}

where FL is the final label value, EL is the engagement label value, RL is the relevance label value, and w is a value between 0 and 1 that is optimized to balance the engagement label value and the relevance label value. In some embodiments, w is selected during iterative training of the first level search model 268 and can be selected to optimize weights for baseline ranker features, e.g., to provide a desired weighting between relevance and engagement.

It will be appreciated that w can be adjusted based on the training dataset provide during training of a first level search model 268, as discussed in greater detail below. For example, in some embodiments, a first training dataset including training data (e.g., historic interaction data, historic search data, historic user data, etc.) for a first time period will generate a model in which w is configured to weight the EL value higher than the RL value. Such models can be applied during seasonal periods, to identify item trends in an item catalog, etc. As another example, in some embodiments, a second training dataset including training data for a second time period will generate a model in which w is configured to weight the RL value higher than the EL value. Such models can be applied to provide cold-start recommendations (e.g., to identify item variants within a catalog that are new and/or have limited interaction data), to reduce mismatches between user queries and selected item variants, etc.

In some embodiments, the trained first level search model 268 includes a trained relevance model 270 configured to generate the RL value for each item variant in an item catalog. The trained relevance model 270 can receive a first subset of the variant level item signals 266 and/or a first subset of the user signals 256. The variant level item signals 266 and/or the user signals 256 received by the trained relevance model 270 are utilized to determine a relevance of an item variant to the search query 254. The first subset of the variant level item signals 266 and/or the first subset of user signals 256 can be identified during an iterative training process. In some embodiments, the trained relevance model 270 includes a trained XGBoost model including a distributed gradient boosting library that implements a gradient boosting framework including parallel tree boosting.

In some embodiments, the trained first level search model 268 includes a regression model 272 configured to determine the EL value and/or the final value as a dependent variable of the search query 254, the RL value, one or more user signals 256, and/or one or more variant level item signals 266 (e.g., independent variables). In some embodiments, the trained first level search model 268 includes a trained linear regression model configured to generate the EL value and applies a subsequent combination process to perform the weighted combination of the RL and EL values. In some embodiments, the trained first level search model 268 includes a single integrated model including determination of an EL value and the final value. The trained first level search model 268 can include any suitable model, such as, for example, a trained linear regression model configured to determine the EL value and/or the final value as a dependent variable of the search query 254, the RL value, the second subset of user signals 256, and/or the second subset of variant level item signals 266 (e.g., independent variables).

In some embodiments, a second subset of the variant level item signals 266 and/or a second subset of the user signal 256 is utilized by the regression model 272. The variant level item signals 266 and/or the user signals 256 received by the trained first level search model 268 can be utilized to generate an EL value for an item variant with respect to the relevant network interface. In some embodiments, the second subset of the variant level item signals 266 provided to the trained first level search model 268 includes signals related to the availability of a variant item for further interactions (e.g., in the context of an e-commerce interface, availability signals can be related to stock, delivery times, etc.).

In some embodiments, the trained first level search model 268 includes a search framework configured to generate a baseline value for each item variant in a catalog. For example, in some embodiments, the trained first level search model 268 includes a Solr search framework modified to generate an RL value (e.g., through inclusion of a relevance model 270), an EL value, and a baseline value according to the methods disclosed herein. It will be appreciated that a search framework modified to include the disclosed variant-aware search methods can apply additional criteria for generating one or more values, such as an RL value, an EL value, or a baseline value, of a variant item with respect to a search query and/or other inputs. For example, to continue the example from above, a modified Solr search platform is configured to apply a token delta between a query and an item as part of a search ranking, and such behavior can be incorporated into generation of a final value, as disclosed herein.

In some embodiments, the first level search model 268 generates the set of candidate items by selecting the individual item variants having the highest baseline value and excluding additional variants of a selected item. As one non-limiting example, a first level search model 268 can determine that a first variant of a first item (V_{1,1}) has a first baseline value (FL₁), a first variant of a second item (V_{1,2}) has a second baseline value (FL₂), a second variant of a first item (V_{2,1}) has a third baseline value (FL₃), and a first variant of a third item (V_{1,3}) has a fourth baseline value (FL₄), where FL₁>FL₂>FL₃>FL₄. A ranking model 274 can be configured to rank each of the item variants by baseline value to generate a ranked set, e.g., [V_{1,1}, V_{1,2}, V_{2,1}, V_{1,3}]. In this example, the first level search model 268 is configured to select a set of 3 candidate items (e.g., M=3). The first level search model 268 selects V_{1,1} as the first item in the set of M variant items and V_{1,2} as the second item in the set of M variant items, i.e., the variant items having the first and second highest baseline values. When the first level search model 268 reaches the third ranked item, e.g., V_{2,1}, the first level search model 268 determines that a different variant, e.g., V_{1,1}, of this item has already been selected and skips this variant, moving to and selecting the fourth ranked item, generating a set of M candidate items of [V_{1,1}, V_{1,2}, V_{1,3}].

In some embodiments, the set of M candidate items generated by the first level search model 268 is provided to a second level search model 276 configured to generate a set of variant-aware search results 278. The trained second level search model 276 can be configured to implement any suitable search ranking framework, such as a vector space model, a learning to rank model, etc. As one example, in some embodiments, the trained second level search model 276 includes one or more of a resource, motivation, strategy framework and/or a regression modeling framework.

The second level search model 276 re-ranks the individual variant items provided in the set of M candidate items to generate the set of variant-aware search results 278. The second level search model 276 utilizes ranking criteria that can produce a different ranking order as compared to the order of item variants in the set of candidate items. For example, in some embodiments, the second level search model 276 is configured to apply ranking criteria and/or a ranking framework that considers alternative and/or additional user signals 256 and/or item signals 266. As another example, in some embodiments, the second level search model 276 is configured to utilize ranking criteria that includes considerations other than the relevance and/or engagement values of the individual item variants, such as, for example, seasonal campaigns, explore-exploit considerations, promoted or recommended item rankings, etc. The second level search model 276 can utilize any suitable inputs, such as, for example, one or more user signals 256, item signals 266, etc., to generate the set of variant-aware search results 278. The variant-aware search results 278 are provided form the variant-aware search engine 264 to the interface generation engine 258.

In some embodiments, the variant-aware search engine 264 is configured to incorporate one or more additional values and/or signals for generating a baseline ranking of each item variant. For example, in some embodiments, the variant-aware search engine 264 includes a quality value configured to identify the quality of one or more elements associated with a variant item. For example, the quality value can be representative of the quality of an image associated with an item variant (e.g., high quality images and/or images matching a predetermined criteria having higher scores), quality of a description (e.g., longer descriptions and/or descriptions matching a predetermined criteria having higher scores), etc. As another example, in some embodiments, the variant-aware search engine 264 includes a cold start discoverability bias that increases a baseline value for cold-start items related to a highest-ranked item variant (e.g., presenting a highest-ranked cold-start item variant in place of a highest-ranked item variant). As yet another example, in some embodiments, the variant-aware search engine 264 is configured to incorporate item engagement at a query level (e.g., engagement with an item result as specifically presented as part of search results for queries). It will be appreciated that the variant-aware search engine 264 can be modified to incorporate any additional signals and/or values for selecting item variants for inclusion in the set of candidate items.

At step 210, the interface generation engine 258 receives the generated set of variant-aware search results 278 and generates an interface 260 including one or more elements representative of at least one of the items in the set of variant-aware search results 278. For example, in some embodiments, the interface generation engine 258 generates a search result interface including programmatically generated interface elements including navigational shortcuts for one or more additional interface pages and/or operations including item elements for items selected from the set of variant-aware search results 278 in descending ranked order. Although specific embodiments are discussed herein, it will be appreciated that the interface generation engine 258 can include any suitable processes for selecting items from the set of variant-aware search results 278, such as, for example, a descending selection process, an explore-exploit selection process, etc.

At step 212, the generated interface 260 (e.g., instructions for generating the interface 260 on a local display) are transmitted to a device that initially generated the request for the interface 252, for example, user system 22a. In some embodiments, the transmitted instructions automatically cause the receiving device to generate the interface 260 including the one or more variant-aware search results 278 and generates an interface 260 including one or more elements representative of at least one of the items in the set of variant-aware search results 278. In some embodiments, the instructions cause the device to update or modify a portion of a default interface template and/or a preexisting page displayed via the device.

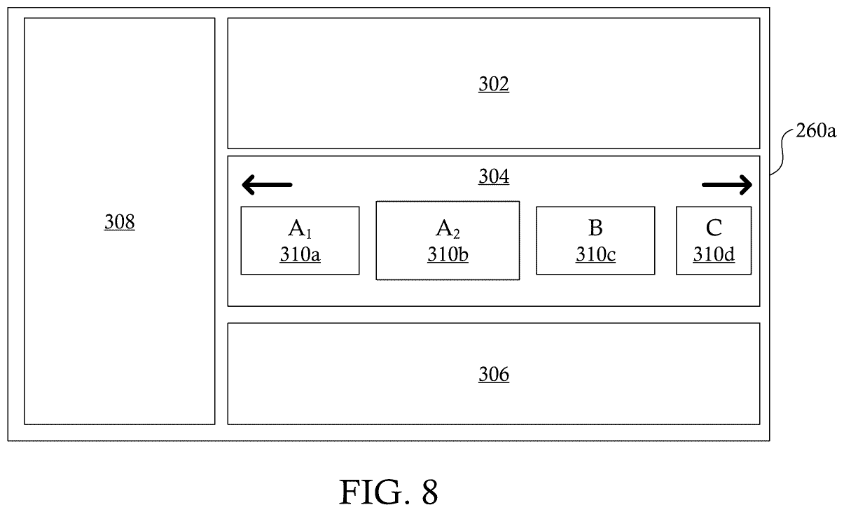

FIG. 8 illustrates an interface 260a including content elements 310a-310d representative of variant items selected from a set of variant-aware search result 278, in accordance with some embodiments. The interface 260 includes a header section 302, a search results container 304, a footer section 306, and a sidebar 308. In some embodiments, the header section 302 can include a search bar or other search interface configured to receive or display a user search query. Although a specific embodiment of interface 260a is illustrated, it will be appreciated that any suitable interface elements and/or containers can be included in a generated user interface 260. The search results container 304 includes programmatically selected content elements 310a-310d representative of items selected from the set of variant-aware search results 278, as discussed above.

The incorporation of the content elements 310a-310d in interface 260 provides higher quality search results as compared to a default or base search that considers only a single, predetermined variant of an item (e.g., lowest price variant). Interfaces generated according to the systems and methods provided herein provide diversity in items presented within the interface while simultaneously presenting content elements representative of variant recommended items that are a close match to a user context (e.g., have a higher relevance to the user query, user intent, etc.) and/or that have a higher likelihood of engagement.

Locating interface pages containing elements associated with variant items in response to a search query can be burdensome and time consuming for users, especially where a search system provides results based only on a single, predetermined version of an item available in a catalog or database. Typically, a user can locate information regarding variant items by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest.

For example, when a user attempts to locate information regarding variant items based on a search query, e.g., interface pages and/or interface elements related to variant items, users typically must first identify an interface element that may not be related to the variant of interest (for example, identifying a first variant of an item having a first design (such as a tent having a first character print) where the user is looking for items having a second design (such as a tent having a second character print that is unrelated to the first character print). The user must then identify or verify that one or more variant versions of the item exists. The user must then browse through multiple levels of nodes or pages to determine if the desired variant exists and, if so, to arrive at the variant element or interface page. Thus, the user frequently has to perform numerous navigational steps to arrive at a page containing information regarding variant items that are of higher relevance to the user, e.g., having a higher relevance to the user search query/user context and/or having a higher likelihood of engagement.

Systems including variant-aware search engines, as disclosed herein, significantly reduce this problem, allowing users to locate relevant variant items or elements with fewer, or in some case no, active steps. For example, in some embodiments described herein, when a user is presented with an interface page including variant search results, each interface element includes, or is in the form of, a link to an interface page for each returned item, including the specific variant item of interest. Each result item thus serves as a programmatically selected navigational shortcut to an interface page, allowing a user to bypass the navigational structure of the browse tree. Beneficially, programmatically identifying variant items and presenting a user with navigations shortcuts to tasks or pages associated with the variant items can improve the speed of the user's navigation through an electronic interface, rather than requiring the user to page through multiple other pages in order to locate a relevant or desired variant via the browse tree or via a search function. This can be particularly beneficial for computing devices with small screens, where fewer interface elements can be displayed to a user at a time and thus navigation of larger volumes of data is more difficult.

With reference again to FIGS. 6-7, at optional step 214, feedback data 280 is received from the device that received the interface 260, e.g., user system 22a. The feedback data 280 is indicative of one or more interactions with the generated interface 260. Feedback data 280 can include, but is not limited to, interaction metrics such as click rates, add-to-cart, etc. The feedback data 280 can be provided directly from the user system 22a and/or can be obtained implicitly from interactions between the user system 22a and a system, such as the frontend system 24. In some embodiments, the feedback data 280 can be stored in a database.

At optional step 220, an updated variant-aware search engine 264a is generated and deployed for use in generating sets of variant-aware search results 278. The updated variant-aware search engine 264a can be generated by a model generation engine 282 implemented by any suitable system, such as, for example, the model generation system 28. In some embodiments, the updated variant-aware search engine 264a includes one or more updated sub-models, such as, for example, an updated first level search model 270a, an updated second level search model 276a, an updated relevance model, an updated regression model, an updated ranking model, etc. Although embodiments are illustrated including generation and deployment of an updated variant-aware search engine 264a, in some embodiments, one or more updated sub-models are generated and deployed without re-generating portions of the variant-aware search engine 264 that are not updated.

The disclosed systems and methods, such as the method of generating an interface 200 discussed above with respect to FIGS. 6-7, provide variant-aware search results that have a higher relevance for the user query and/or higher engagement (e.g., popularity) as compared to some current search systems. The disclosed variant-aware search engine 264 can be modified or adjusted, for example based on a training dataset, to weight one of the relevance or the engagement higher, as discussed above.

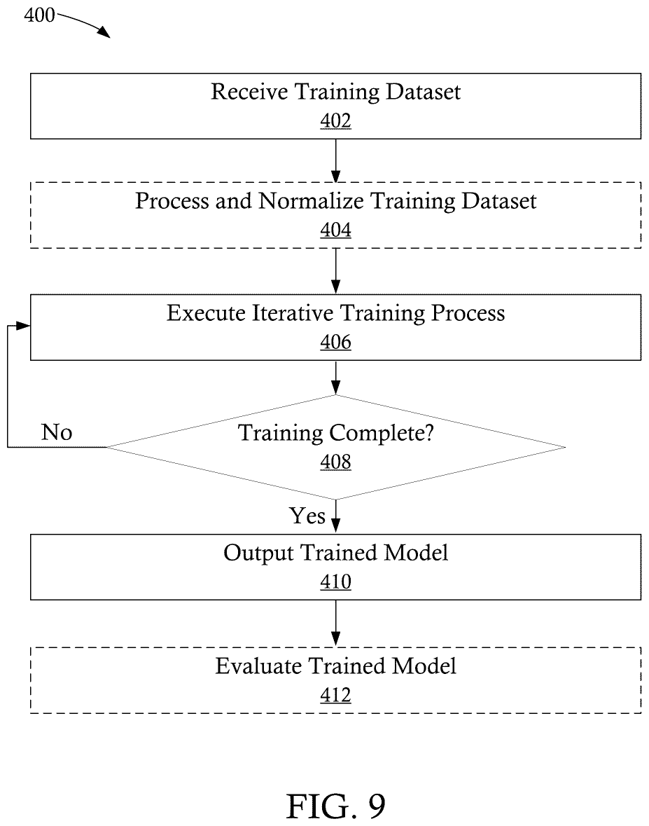

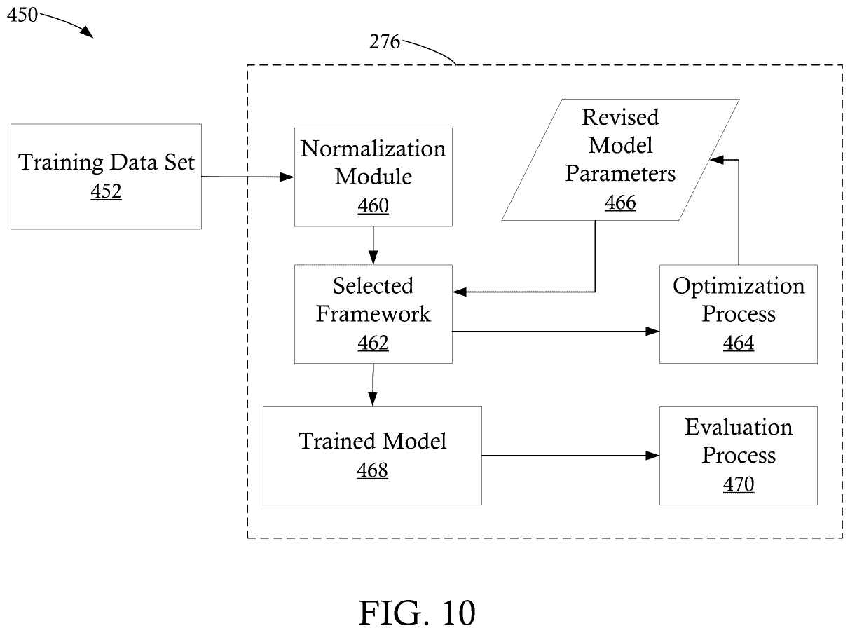

In some embodiments, a variant-aware search engine 264a can include one or more trained models, such as a trained first level search model 268 and/or a trained second level search model 276. In addition, in some embodiments, a trained model, such as a trained first level search model 268, can include one or more trained sub-models, such as a trained relevance model 270, a trained regression model 272, a trained ranking model 274, etc. In some embodiments, one or more trained models can be generated using an iterative training process based on a training dataset. FIG. 9 illustrates a method 400 for generating a trained model, such as a trained first level search model 268, a trained relevance model 270, a trained regression model 272, and/or a trained ranking model 274, in accordance with some embodiments. FIG. 10 is a process flow 450 illustrating various steps of the method 400 of generating a trained model, in accordance with some embodiments. At step 402, a training dataset 452 is received by a system, such as model generation system 28. The training dataset 452 can include labeled and/or unlabeled data. For example, in some embodiments, a set of labeled and/or semi-labeled data is provided for use in training a model.

In some embodiments, the training dataset 452 includes historical interaction data. The historical interaction data can include data representative of interaction between one or more users with one or more generated interface pages, such as views, click rates, add-to-cart, etc. Historical interaction data can include item-generic interaction data, e.g., data representative of all interactions with any variation of an item and/or any content element including a variation of an item and/or variant-specific interaction data.

In some embodiments, the training dataset 452 includes item feature data. The item feature data can include one or more item features extracted for an item and/or one or more variants of an item included in an item catalog. As discussed above, item features can include item-generic and/or variant-specific features. In the context of an e-commerce environment, the item features can include, but are not limited to, brand, style, department, size, color, flavor, format, print, material, finish, etc.

In some embodiments, the training dataset 452 includes at least partially labeled training data. For example, in some embodiments, the training dataset 452 consists of a plurality of input datasets each including one or more search queries, associated user features, an item set, and associated item features (including one or more variant item features) and a label for each input dataset identifying a set of ideal search results and/or interactions (e.g., identifying a set of items having high interaction scores as a result of the input dataset). In some embodiments, the training dataset 452 includes identifiers for obtaining features from pre-existing feature sets stored in one or more storage locations. For example, in some embodiments, the training dataset 452 can include a set of reference identifiers for retrieving features from a relevant database, such as a variant feature database 30.

In some embodiments, the training dataset 452 includes precalculated EL values and/or RL values. The precalculated values can include training input, e.g., values configured to be received by a model as an input, and/or as target outputs, e.g., precalculated final values for calculating a loss function of a model during iterative training. The relevant values can be generated using any suitable process, such as a previously generated model, algorithm, etc.

At optional step 404, the received training dataset 452 is processed and/or normalized by a normalization module 460. For example, in some embodiments, the training dataset 452 can be augmented by imputing or estimating missing values of one or more features associated with an item variant. In some embodiments, processing of the received training dataset 452 includes outlier detection configured to remove data likely to skew training of a variant-aware search engine and/or one or more sub-models. In some embodiments, processing of the received training dataset 452 includes removing features that have limited value with respect to training of the variant-aware search model (or related sub-models).

At step 406, an iterative training process is executed to train a selected model framework 462. The selected model framework 462 can include an untrained (e.g., base) machine learning model, such as a vector-space framework, a learning to rank framework, a deep learning framework, a logistical regression framework, an XGBoost framework, and/or a partially or previously trained model (e.g., a prior version of a trained first level search model 268, a trained relevance model 270, a trained regression model 272, a trained ranking model 274, etc.). The training process is configured to iteratively adjust parameters (e.g., hyperparameters) of the selected model framework 462 to minimize a cost value (e.g., an output of a cost function) for the selected model framework 462. In some embodiments, the cost value is related to a match between predicted behavior, e.g., a set of generated search results and a set of ideal or desired search results, a predicted interaction such as a click through or add-to-cart and actual interaction behavior, etc.

The training process is an iterative process that generates set of revised model parameters 466 during each iteration. The set of revised model parameters 466 can be generated by applying an optimization process 464 to the cost function of the selected model framework 462. The optimization process 464 can be configured to reduce the cost value (e.g., reduce the output of the cost function) at each step by adjusting one or more parameters during each iteration of the training process.

After each iteration of the training process, at step 408, a determination is made whether the training process is complete. The determination at step 408 can be based on any suitable parameters. For example, in some embodiments, a training process can complete after a predetermined number of iterations. As another example, in some embodiments, a training process can complete when it is determined that the cost function of the selected model framework 462 has reached a minimum, such as a local minimum and/or a global minimum.

At step 410, a trained model 468, such as a trained first level search model 268, a trained relevance model 270, a trained regression model 272, a trained ranking model 274, a trained second level search model 276, etc. is output and provided for use in an interface generation method, such as the method of generating an interface 200 discussed above with respect to FIGS. 6-7.

At optional step 412, a trained model can be evaluated by an evaluation process 470. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory;
a processor communicatively coupled to the non-transitory memory, wherein the processor is configured to read a set of instructions to:
receive a request for an interface including a search query from a first device;
generate, by a first level search model, a set of candidate items based on the search query, wherein the first level search model generates a baseline value for each item variant in an item catalog, wherein the baseline value comprises a weighted combination of a relevance label value and an engagement label value, and wherein the set of candidate items is selected based on the baseline value;
generate, by a second level search model, a set of search results based on the set of candidate items;
generate an interface including interface elements representative of one or more item variants in the set of search results; and
transmit the interface to the first device.

2. The system of claim 1, wherein the first level search model comprises a relevance model configured to generate the relevance label value based on the search query, a set of user features, and a set of variant item features, wherein the set of variant item features are representative of one or more features that vary between a first variant of an item and a second variant of the item.

3. The system of claim 2, wherein the set of variant item features include one or more features that are constant between the first variant of the item and the second variant of the item.

4. The system of claim 1, wherein the first level search model comprises a regression model configured to generate the engagement label value.

5. The system of claim 1, wherein the first level search model generates the set of candidate items by:
ranking each item variant in the item catalog by the baseline value to generate a ranked variant list; and
selecting a set of M highest ranked items from the ranked variant list, wherein when a first variant of an item is selected, the first level search model is configured to exclude second variants of the item from the set of M highest ranked items.

6. The system of claim 1, wherein the second level search model comprises a ranking model configured to re-rank the set of candidate items.

7. The system of claim 1, wherein the weighted combination of the relevance label value and the engagement label value includes a cold-start bias.

8. The system of claim 1, wherein the baseline value for each item variant in an item catalog is generated based on an image quality score.

9. The system of claim 1, wherein the first level search model comprises a relevance model including a gradient boosting framework configured to generate the relevance label value, a regression model including a linear regression framework configured to generate the engagement label value, and a ranking framework configured to rank each item variant by the weighted combination of the relevance label value and the engagement label value.

10. A computer-implemented method, comprising:
receiving a request for an interface including a search query from a first device;
generating a set of candidate items based on the search query, wherein the set of candidate items is generated by a first level search model configured to generate a baseline value for each item variant in an item catalog, wherein the baseline value comprises a weighted combination of a relevance label value and an engagement label value, and wherein the set of candidate items is selected based on the baseline value;
implementing a second level search model to generate a set of search results based on the set of candidate items;
generating an interface including interface elements representative of one or more item variants in the set of search results; and
transmitting the interface to the first device.

11. The computer-implemented method of claim 10, wherein the first level search model comprises a relevance model including a gradient boosting framework configured to generate the relevance label value, a regression model including a linear regression framework configured to generate the engagement label value, and a ranking framework configured to rank each item variant by the weighted combination of the relevance label value and the engagement label value.

12. The computer-implemented method of claim 11, wherein the relevance model is configured to generate the relevance label value based on the search query, a set of user features, and a set of variant item features, wherein the set of variant item features are representative of one or more features that vary between a first variant of an item and a second variant of the item.

13. The computer-implemented method of claim 12, wherein the set of variant item features include one or more features that are constant between the first variant of the item and the second variant of the item.

14. The computer-implemented method of claim 10, generating a set of candidate items comprises:
ranking each item variant in the item catalog by the baseline value to generate a ranked variant list; and
selecting a set of M highest ranked items from the ranked variant list, wherein when a first variant of an item is selected, the first level search model is configured to exclude second variants of the item from the set of M highest ranked items.

15. The computer-implemented method of claim 10, wherein the second level search model comprises a ranking model configured to re-rank the set of candidate items.

16. The computer-implemented method of claim 10, wherein the weighted combination of the relevance label value and the engagement label value includes a cold-start bias.

17. The computer-implemented method of claim 10, wherein the baseline value for each item variant in an item catalog is generated based on an image quality score.

18. A non-transitory computer-readable medium having instructions stored thereon that when executed by a processor cause a device to perform operations comprising:
receiving a request for an interface including a search query from a first device;
generating a relevance label value for each item variant in an item catalog based on the search query, a set of user features, and a set of variant item features;
generating an engagement label value for each item variant in the item catalog based on the search query and a set of historic interaction data;
generating a weighted combination of the relevance label value and the engagement label value for each item variant in the item catalog;
ranking each item variant in the item catalog by a first ranking criteria including the weighted combination of the relevance label value and the engagement label value to generate a ranked variant list;
selecting a set of candidate items based on the ranked variant list;
generating a set of search results by re-ranking the set of candidate items according to a second ranking criteria;
generating an interface including interface elements representative of one or more item variants in the set of search results; and
transmitting the interface to the first device.

19. The non-transitory computer-readable medium of claim 18, wherein selecting a set of candidate items comprises selecting a set of M highest ranked items from the ranked variant list, wherein additional variants of a first item are excluded the set of M highest ranked items when a first variant was previously selected for inclusion in the set of M highest ranked items.

20. The non-transitory computer-readable medium of claim 18, wherein the relevance label value is generated by a relevance model including a gradient boosting framework and the engagement label value is generated by a regression model including a linear regression framework.
